(19) United States
(12) Patent Application Publication
(10) Pub. No.: US 2015/0094871 A1
(43) Pub. Date: Apr. 2, 2015

(54) MANAGING DEVICES IN MICRO-GRIDS

(71) Applicant: INTERNATIONAL BUSINESS MACHINES CORPORATION, Armonk, NY (US)

(72) Inventors: Gopal K. Bhageria, Overland Park, KS (US); Kevin A. Klein, Houston, TX (US); Jean-Gael F. Reboul, Kenmore, WA (US)

(73) Assignee: INTERNATIONAL BUSINESS MACHINES CORPORATION, Armonk, NY (US)

(21) Appl. No.: 14/039,534

(22) Filed: Sep. 27, 2013

(51) Int. Cl. H02J 4/00

(52) U.S. Cl. CPC H02J 4/00
USPC 700/297

(57) ABSTRACT

An approach to provide power from power supply devices to power consuming devices using a centralized system. The approach includes a method for configuring micro-grids that comprises the steps of receiving information of a power consuming device and criticality of the power consuming device from a universal appliance service (UAS) system. The method further includes receiving power supply information of one or more power supply devices associated with an electric grid from the UAS system. The method further includes receiving a power request from the power consuming device. The method further includes determining, by a computing device, power requirements for the power consuming device based on the information, the criticality of the power consuming device, and the power supply information.

### BACKGROUND

1. Field of the Invention

The present invention generally relates to power distribution, and more particularly, to methods and systems for providing power from power supply devices to power consuming devices using a centralized system.

2. Description of the Related Art

Electrical power networks include a number of different systems, such as a generation system, a transmission system, and a distribution system. The distribution system (i.e., distribution grid or distribution network) traditionally receives power from one or more high-voltage sources of the transmission system and distributes that power to feeder lines. To distribute power within the electrical power network, the distribution system can transform voltage (e.g., stepping down power from a transmission voltage level to a distribution voltage level), regulate voltage (e.g., adjusting the voltage of feeder lines as loads are added and removed), conserve power, regulate power, switch and protect different parts of the distribution system (e.g., using switches, circuit breakers, reclosers, and fuses that connect or disconnect portions of the distribution system) between different generation systems, and/or any other operations.

Technology has transformed distribution grids into decentralized systems which allow a variety of power generation and storage components to be located at a power user's location instead of having a central location (e.g., a power plant) that provides power for all the power users. For example, premises (e.g., a home or a business) within the distribution grid may operate their own energy resources (e.g., solar cells, wind turbines, and batteries) that can also provide power to the distribution grid. An operator of the distribution grid (e.g., a utility or a third-party company) uses smart energy devices (e.g., ZigBee® of ZigBee Alliance Corp., San Ramon, Calif.) to remotely control components of the distribution grid.

### SUMMARY

In a first aspect of the invention, a method for configuring micro-grids includes the steps of receiving information of a power consuming device and criticality of the power consuming device from a universal appliance service (UAS) system. The method further includes receiving power supply information of one or more power supply devices associated with an electric grid from the UAS system. The method further includes receiving a power request from the power consuming device. The method further includes determining, by a computing device, power requirements for the power consuming device based on the information, the criticality of the power consuming device, and the power supply information.

In another aspect of the invention, a system for configuring a micro-grid includes a CPU, a computer readable storage memory, and a computer readable storage media. Additionally, the system includes program instructions to receive information for power consuming devices and power supply information for power supply devices from validated third party sources other than the power consuming devices. The system also includes program instructions to determine criticality levels of the power consuming devices based on a location for each of the power consuming devices and a device type for each of the power consuming devices. The system also includes program instructions to send the criticality levels to a micro-grid manager. The micro-grid manager determines that power is available from the power supply devices to operate the power consuming devices based on the criticality levels. Each of the program instructions are stored on the computer readable storage media for execution by the CPU via the computer readable memory.

In an additional aspect of the invention, there is a computer program product for determining criticality. The computer program product includes a computer usable storage medium having program code embodied in the storage medium. The program code is readable/executable by a computing device operable to receive real time information for a power consuming device from a UAS system, the real time information includes the criticality of the power consuming device. The computer program product includes receiving real time power supply information of a power supply device from the UAS system. The computer program product includes determining a power flow for a micro-grid based on the real time information and the power supply information. The computer program product includes determining reliability of the micro-grid based on the power flow. The computer program product includes determining real time electrical status of the micro-grid based on the real time information and the real time power supply information. The computer program product includes receiving an enablement request for power from the power consuming device. The computer program product includes determining whether there is available power for the power consuming device based on the real time electrical status of the micro-grid. The computer program product includes determining whether the power consuming device has priority for the available power over other power consuming devices based on the criticality of the power consuming device. The computer program product includes sending the available power to the power consuming device based on the priority of the power consuming device.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with aspects of the invention.

FIG. 2 shows a functional block diagram of an environment for configuring micro-grids in accordance with aspects of the invention.

FIG. 3 shows a functional block diagram of an exemplary environment for managing a micro-grid using Session Initiation Protocol (SIP) in accordance with aspects of the invention.

FIG. 4 shows a functional block diagram of an exemplary environment for managing a micro-grid using Message Queue Telemetry Transport (MQTT) protocol in accordance with aspects of the invention.

FIGS. 5-8 show flow diagrams of an exemplary process for configuring a micro-grid in accordance with aspects of the present invention.

### DETAILED DESCRIPTION

The present invention generally relates to electrical power distribution, and more particularly, to methods and systems for providing power from power supply devices to power consuming devices using a centralized system. In embodiments, the present invention utilizes a universal appliance service (UAS) system to provide a micro-gird manager with electrical characteristics for power consuming devices and power supply devices. In embodiments, the UAS system is registered directly and under control of the micro-grid manager which is external to a customer or power supplier network. In this way, a secure system to provide information is obtained by implementing aspects of the present invention. More specifically, by implementing the present invention, all priorities and electrical information of the power consuming device, for example, will be determined by the UAS system. As such, the power consuming device will not provide such information to the micro-grid manager and, accordingly, all device information and priorities of the power consuming device can be consistently and securely provided to the micro-grid manager. This is in contrast to when the power consuming device provides such information, which, in such case, results in electrical characteristics and priorities being defined differently by different parties and/or users associated with the micro-grid.

In embodiments of the present invention, the UAS system determines priorities for power consuming devices and also determines the criticality level of the device. The micro-grid manager uses the priorities and the electrical characteristics to determine when and which power consuming devices are to receive power from the power supply devices. Accordingly, the present invention results in a centralized and secure system that ensures sustainability, reliability, and power quality within a micro-grid by generating control information based on the currently available power supply output and reserves. This ensures that devices are not given electrical characteristics and priorities which are being defined differently by different parties and/or users associated with the micro-grid.

In embodiments, a power demand associated with one or more different power consuming devices (e.g., air-conditioning unit, a washer, etc.) can be compared to the amount of available power from one or more different power supply devices in order to supply electrical power and manage an electric micro-grid system. The management may take into account, for example, an amount of available power in the micro-grid, the criticality level of the power consuming device (e.g., critical, non-critical), the location of the power consuming device and/or power supply device, the time of day, and/or reliability and power quality issues for the micro-grid. In embodiments, the criticality information can be provided by a UAS system that determines different criticality levels of different devices in a consistent and secure manner. Accordingly, implementations of the invention configure, manage, and monitor micro-grids.

In embodiments, a micro-grid manager can determine which devices can operate based on how much power is available and the associated electrical characteristics of the device. In embodiments, the micro-grid manager may store electrical characteristics of the devices, criticality level of the device, device identifier (ID) and other information. For example, the micro-grid manager can receive the criticality level of a device from the UAS system. The UAS system may determine a criticality level for a power consuming device based on the type of device, the location of the device, and/or any special event (e.g., hurricane, earthquake, etc.) that is occurring at a particular time. Further, the micro-grid manager may also receive electrical characteristics (e.g., power consumption or supply values given in kilowatts, megawatts, etc.) from the UAS system for different devices. Accordingly, the micro-grid manager can then control operation of one or more power consuming devices and/or one or more power supply devices based on the time of day, time of season, etc., or other characteristics of the device or electrical grid. Further, the micro-grid manager can generate control information and send this information to an energy management (EM) system or vice versa. The EM system can use the control information to control the power consuming devices and/or the power supply devices.

The control information for a power consuming device can include information about: (i) the amount of load (e.g., the power demand) requirements at different times (e.g., a load requires 100 kilowatts of power from 9:00 a.m. to 4:00 p.m. and 25 kilowatts of power from 4:00 p.m. to 5:00 p.m.), or (ii) device characteristics for different times, e.g., output temperature for chilled water from a chiller or output temperature of heat from electric heat strips in an air handling unit, of the load. The control information may be used to isolate or identify a critical power consuming device, e.g., a life support device, and/or a non-critical power consuming device, e.g., a television. Also, the control information for a power supply device can include information about the amount of power supply to be provided by a power supply device at different times or other criteria.

As it should be understood, a micro-grid is a self-sufficient island that is electrically isolated (i.e., islanded) from the rest of a distribution grid and that includes sufficient energy resources to satisfy power demanded by power consuming devices within the micro-grid. For example, an area of a distribution grid may include one or more premises (e.g., residences, offices, or facilities) including devices that consume electrical power (e.g., lights and appliances) and energy resources that provide electrical power (e.g., fuel cells, micro-turbines, generators, solar cells, wind turbines, etc.). A micro-grid may include a subset of the premises that, in combination, produce sufficient power to meet the total power consumed within the subset of the premises. A utility operator, or another type of third-party operator (e.g., a utility customer with their own generation or co-generation system, or an independent power producer), may create the micro-grid by opening switching elements in the distribution grid that electrically isolate the premises within an area of the distribution grid from the remainder of the distribution grid.

In embodiments, a utility provider can dynamically create and/or reconfigure micro-grids to minimize the number of customers affected by an event that disrupts power delivery to portions of a distribution grid. Such events may include maintenance, construction, severe weather, natural disasters, man-made disasters, etc. For example, in response to a snowstorm that causes parts of the distribution grid to fail, the utility operator (e.g., a power provider, distributer, and/or manager) may remotely control switches (e.g., using supervisory control and data acquisition (SCADA) controllers) installed in the distribution grid to configure and establish one or more micro-grids. After the disruption ends (e.g., the damage has been repaired), the utility operator may reconfigure the distribution grid to dissolve the micro-grids without affecting the stability and reliability of the distribution grid.

Further, aspects of the invention manage micro-grids by dynamically controlling distributed energy resources and energy consumption devices at premises within the distribution grid (e.g., homes and business locations). For example, the disclosed systems and methods may monitor conditions within a micro-grid and, in response to changes in the conditions (e.g., changes in or supply or demand), issue commands to remotely modify (i.e., tune) the operation of the devices within the micro-grid to generate or consume more or less power. By doing so, the utility operator enhances the reliability and robustness of the service provided to its customers. Additionally, the utility operator can maximize the use of local energy resources to satisfy the local energy demand, thereby reducing potential negative environmental impacts of power generation (e.g., soot from coal-fired power plants).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium and/or device (hereinafter referred to as computer readable storage medium). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

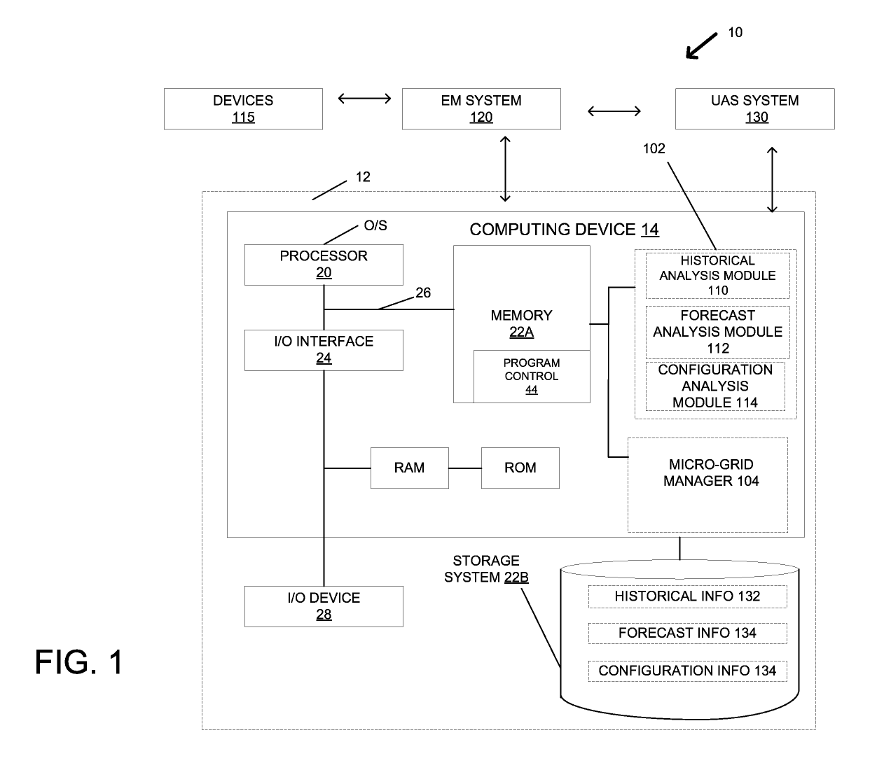

FIG. 1 shows an illustrative environment 10 for managing the processes in accordance with the invention. To this extent, environment 10 includes a server 12 or other computing system, devices 115, energy management (EM) system 120, and UAS system 130.

In embodiments, EM system 120 can be part of device 115, and can be used to provide information for the server 12, e.g., micro-grid manager 104. The devices 115 can be, e.g., either power consuming devices or power supply devices. By way of non-limiting examples, power supply devices can be generators, turbines, fuel cells, micro-turbines, or any other type of device that generates power. By way of non-limiting examples, power consuming devices may be any device that consumes power, such as lighting devices, cooling devices, motors, pumps, machinery and/or any other type of power consuming device.

In embodiments, the power consuming devices can be either critical or non-critical devices. By way of non-limiting examples, a critical power consuming device may be any device used to provide heat, cooling, lighting, pumping, and/or any other operation that is used at governmental or medical facilities, e.g., a hospital, a police station, or a prison, as well as devices used to provide support during catastrophic events (e.g., a hurricane, an earthquake, etc.). For example, a critical power consuming device may be a particular type of medical equipment within a hospital, lighting systems at a prison, and/or pumping systems at a fire station. On the other hand, a non-critical power consuming device may be a television or any other type of device not associated with a critical power consuming device.

In particular, computing system 12 includes a computing device 14. Computing device 14 can be resident on a network infrastructure or computing device of a third party service provider (any of which is generally represented in FIG. 1). Computing device 14 also includes a processor 20, memory 22A, an I/O interface 24, and a bus 26. Memory 22A can include local memory employed during actual execution of program code, bulk storage, and cache memories which provide temporary storage of at least some program code in order to reduce the number of times code must be retrieved from bulk storage during execution. In addition, computing device 14 includes random access memory (RAM), a read-only memory (ROM), and an operating system (O/S).

Computing device 14 is in communication with external I/O device/resource 28 and storage system 22B. For example, I/O device 28 can include any device that enables an individual to interact with computing device 14 (e.g., user interface) or any device that enables computing device 14 to communicate with one or more other computing devices using any type of communications link. External I/O device/resource 28 may be for example, a handheld device, PDA, handset, keyboard etc.

In general, processor 20 executes computer program code (e.g., program control 44), which can be stored in memory 22A and/or storage system 22B. Moreover, in accordance with aspects of the invention, program control 44 controls a configuration engine 102 and/or a micro-grid manager 104, e.g., the processes described herein. Configuration engine 102 and micro-grid manager 104 can be implemented as one or more program code in program control 44 stored in memory 22A as separate or combined modules. Additionally, configuration engine 102 and micro-grid manager 104 may be implemented as separate dedicated processors or a single or several processors to provide the function of these tools. Further, configuration engine 102 and micro-grid manager 104 (along with their respective data and modules) can be implemented in separate devices. Moreover, configuration engine 102 and micro-grid manager 104 (along with their respective data and modules) can be implemented in different planes of a network (e.g., a control plane and a service plane).

In accordance with aspects of the invention, configuration engine 102 is hardware, software, or a combination thereof that configures a micro-grid within a distribution grid. In embodiments, configuration engine 102 determines demand by power consuming devices within the micro-grid and whether such demand can be met within that micro-grid. Power consuming devices include, for example, home appliances, lighting, electric vehicles, etc. The energy resources include variable energy resources (VERs) and distributed energy resources (DERs), including, e.g., generators (e.g., gas, wind, solar, etc.) and energy storage devices (e.g., electric batteries, fuel cells, electric vehicles, etc.).

In embodiments, configuration engine 102 issues messages to control elements of the distribution grid (e.g., switches connected to SCADA controllers) in order to modify the topology of the electrical distribution network and create or modify the micro-grid. For example, the configuration engine 102 may dynamically modify a micro-grid by reducing the number of connected premises and/or consuming devices within the micro-grid based on current conditions (e.g., weather, load, power generation, etc.) within the distribution grid.

Still referring to FIG. 1, in accordance with aspects of the invention, the configuration engine 102 includes a historical analysis module 110, a forecast analysis module 112, and/or a configuration analysis module 114. Historical analysis module 110 is hardware, software, or a combination thereof that analyzes historical information, such as historical information 132 in storage system 22B. In embodiments, historical information 132 may be collected from devices 115, such as power supply devices (e.g., micro-turbines, generators, etc.) and/or power consuming devices (e.g. motors, life-support systems, MRI machine, lighting, etc.), associated with the distribution grid and/or third-party sources.

In embodiments, historical information 132 may be collected from EM system 120, which receives this information directly from devices 115. Historical information 132 includes, for example, past weather conditions (e.g., temperature, precipitation, wind directions and forces, barometric pressure, and sky conditions, etc.), electrical conditions (e.g., voltage, current, real, reactive, and apparent power, etc.), network topology, power outage information, communications' infrastructure information (e.g., operating status, location, clients, etc.), and asset information (e.g., identification, host network, location, etc.). Historical analysis module 110 aggregates, correlates, filters, and/or enriches historical information 132 using conventional data analysis techniques. For example, historical analysis module 110 may average power demand data at different locations (e.g., premises) over a time period to generate a digest of historical information 132 that associates locations of a distribution grid (including micro-grids) with power demand at different time frames (e.g., monthly, daily, hourly, etc.).

Forecast analysis module 112 is hardware, software, or a combination thereof that combines historical information (e.g., the digest of historical information determined by historical analysis module 110) and forecast information, such as forecast information 134 in storage system 22B, to determine forecasted near-term conditions in the electrical network. Forecast information 134 may be information generated by the utility operator and/or obtained from third-party sources. For example, forecast information 134 includes weather forecast information, local forecast information, and power generation forecast information (including wind, solar, temperature, etc.). Forecast analysis module 112 may analyze forecast information 134 using one or more predefined models to forecast near-term conditions of the distribution grid. For example, based on energy consumption information and energy generation information, forecast analysis module 112 generates a data structure that associates locations (e.g., premises) of an electrical grid (including micro-grids) with predicted power demand at different times in the near-future (e.g., days, hours, minutes, etc.). The generated forecast may be continually and/or periodically updated (e.g., in real-time).

Configuration analysis module 114 is hardware, software or a combination thereof that determines network topology, including micro-grid configurations, based on historical information, forecast information and/or the current state of the distribution grid. In embodiments, based on the forecasted near-term conditions determined by forecast analysis module 112, configuration analysis module 114 determines configuration information 136, which defines locations (e.g., premises) that can be electrically isolated into one or more micro-grids that include energy resources (e.g., distributed and/or variable energy resources, such as wind turbines) that can generate a greater amount of power than consumed by energy consuming devices (e.g., appliances) operating within the micro-grid. Configuration analysis module 114 may analyze the near-term forecast information and/or the current state information using conventional techniques. For, example configuration analysis module 114 may analyze the information using data event and data pattern matching, graph exploration, Monte-Carlo simulation, stochastic and Las Vegas algorithms, approximation, and/or genetics heuristics using rules-based or model-based datasets, to aggregate, correlate and analyze the above real-time and historical information sources to define the optimal network configuration for micro-grids. An optimal configuration for a micro-grid may include a mix of energy resources and energy consuming devices that maximize the number of users in one or more micro-grids.

In accordance with aspects of the invention, micro-grid manager 104 is hardware, software, or a combination thereof that implements and manages micro-grids. In embodiments, micro-grid manager 104 obtains configuration information 136 generated by configuration engine 102 and, based on that information, issues commands to devices within the distribution grid to open switches that isolate one or more portions into a micro-grid. Further, in embodiments, micro-grid manager 104 manages micro-grids by ensuring that demand by power consumers within a particular micro-grid is satisfied by the power providers within that micro-grid. In implementations, using analysis techniques similar to those used by configuration engine 102, micro-grid manager 104 may combine current (e.g., real-time) information received from devices and/or systems in a micro-grid with historical information and forecast information to dynamically tune the performance of energy resources and power consumers within the micro-grid. For example, based on current temperature information received from one or more devices in the distribution grid, micro-grid manager 104 may communicate with smart appliances (e.g., water heater, air conditioner, etc.) in a home area network of premises in the micro-grid and control them to reduce their power consumption.

EM system 120 can receive various types of information, associated with power consuming devices and/or power supply devices, to control the power consuming devices and/or the power supply devices within the micro-grid system. By way of a non-limiting example, EM system 120 can receive location information and identifier information from one or more of the power consuming devices. EM system 120 can send this information to micro-grid manager 104. In embodiments, micro-grid manager 104 may receive electrical power consumption information from devices 115 via EM system 120, e.g., power supply devices and/or power consuming devices that are registered with micro-grid manager 104.

Micro-grid manager 104 uses this information to obtain, from UAS system 130, criticality information and electrical characteristics of devices. Micro-grid manager 104 may use an application programming interface (API) that allows for micro-grid manager 104 to communicate with UAS system 130. UAS system 130 may include one or more computing devices, with each computing device associated with one entity or different entities. An entity could be a utility, a manufacturer of a power consuming and/or supply device, the company that manages the micro-grid, or any other type of entity. In this and other implementations, UAS system 130 may receive the request from micro-grid manager 104 and determine the criticality level of the power consuming device.

In embodiments, UAS system 130 can receive and store information about different power consuming devices and power supply devices. The information may include power consumption information, power supply information, identification numbers, model number, year of manufacture, type of device (e.g., a generator, a chiller, a washing machine, a refrigerator, etc.), and/or any other information describing the mechanical and electrical characteristics of the device. The information is received from reliable sources, such as device manufacturers instead of receiving the information from devices 115. Accordingly, this prevents outside sources from causing disruptions or issues within the micro-grid and also prevents users of devices 115 from providing inaccurate information.

In embodiments, UAS system 130 validates the information which ensures that the information for devices 115 is accurate and authentic. In embodiments, UAS system 130 may have a database of stored information (e.g., device identifier information, device manufacturer identifier information, etc.) regarding different devices and match the received information to the stored information. Using this validated information, UAS system 130 can determine the criticality level of the devices. In embodiments, UAS system 130 can provide the criticality level of the devices directly to micro-grid manager 104. As such, UAS system 130 acts as a centralized system between devices 115 and micro-grid manager 104 for receiving information, validating information, and determining and communicating criticality information.

As an example, UAS system 130 can use information relating to the type of device as a factor in determining a power consuming device's criticality level, e.g., a dialysis machine will have a greater criticality level than a gaming system. Additionally, or alternatively, UAS system 130 can use information relating to the location of the device as a factor in determining a power consuming device's criticality level. For example, a power consuming device located at a hospital can have a greater criticality level than a power consuming device located at a restaurant. Additionally, or alternatively, UAS system 130 can use information relating to the particular time of day, month, year, or other time period as a factor in determining a power consuming device's criticality level. EM system 120 can update stored information based on the change in criticality and send the change in criticality to micro-grid manager 104.

Additionally, or alternatively, UAS system 130 can use information relating to particular events as a factor in determining a power consuming device's criticality level. UAS system 130 may receives information about emergency events, such as hurricanes, tornados, snowstorms, earthquakes, etc. UAS system 130 may use this information to change the criticality level of a power consuming device and send the change in criticality to EM system 120. EM system 120 can update stored information based on the change in criticality and send the change in criticality to micro-grid manager 104. For example, during a natural event (e.g., hurricane) a school may be used as a makeshift hospital or shelter and, as such, the lighting and heating systems may be reclassified as critical. By doing so, micro-grid manager 104 ensures that sufficient energy is produced in the micro-grid to power devices that are operating within the micro-grid.

In embodiments, UAS system 130 can use known algorithms to determine the criticality level. Also, in embodiments, UAS system 130 can use inputs received from a user that assign criticality levels to different types of power consuming devices. For example, a user may input a higher criticality level for power consuming devices located at a hospital than at a supermarket. Also, in any of the embodiments, the criticality levels may be provided as numerical values, e.g., a higher numerical value may indicate a higher criticality level.

UAS system 130 can receive device information, e.g., electrical characteristic information, etc., from a device manufacturer. Also, UAS system 130 can receive connection information from the device in order to be alerted that the device is connected in the micro-grid system. Once this is verified, UAS system 130 can then query verifiable third parties to obtain device information. In an example, the device information is received from a verifiable source, e.g., a device manufacturer to ensure the integrity of the device information. This also ensures that the device information is uniform amongst the same types of device, which prevents any manipulation of the device information at the customer side. The third party source can also provide this information at any time. Accordingly, UAS system 130 can use this information to calculate criticality information and/or the electrical characteristic information, which can be sent to micro-grid manager 104. As such, micro-grid manager 104 uses the criticality information and/or the electrical characteristics to determine which power consuming devices are to receive power.

Upon receiving the electrical characteristics and criticality information, micro-grid manager 104 may update network connectivity information for the micro-grid. The network connectivity information can include information about the total number of power consuming devices and power supply devices connected within the micro-grid as well as devices connected to each other. Micro-grid manager 104 can receive this information in real time and use this information to determine a real time electrical state of the micro-grid. For example, micro-grid manager 104 may use this information to determine if a power quality level or power flow level reaches a threshold (e.g., 75%, 85%, 90%, etc.). Micro-grid manager 104 may also determine the network topology to determine the power flow and the power quality. If the power flow and/or the power quality thresholds are not met, then micro-grid manager 104 may initiate different actions that result in the thresholds being met. Once the thresholds are met, micro-grid manger 104 may process requests to initiate and/or disable power consuming devices or power supply devices.

In embodiments, micro-grid manager 104 can receive a request or make a determination to: (i) provide power to a power consuming device; (ii) stop providing power to a power consuming device; (iii) add a power supply device to provide power to the micro-grid; (iv) deny power to the power consuming device; (v) divert power from one power consuming device to another power consuming device; and/or (vi) ramp up power to reserve power supply devices to provide the additional power. The request may include electric power consumption information and/or power supply information and may be sent from EM system 120 or directly from the power consuming and/or supply devices.

Micro-grid manager 104 may also determine to provide power based on whether the power is being requested by a critical or non-critical power consuming device, as determined by UAS system 130. For example, micro-grid manager 104 may divert power to a critical power consuming device from a non-critical power consuming device or provide controls to receive power generated by a reserve power supply device which is standby mode. Alternatively, micro-grid manager 104 may provide controls to provide power to a non-critical power consuming device if there is available power from the power supply devices. However, when there is no available power, or insufficient available power, the micro-grid manager can generate control information that uses less power and provide power depending on the criticality level of the power consuming device. In the latter situation, micro-grid manager 104 may send a message to the user of the power consuming device that power is not available. The message may be sent to EM system 120 and/or any other computing device (e.g., a smart phone, a laptop, a PDA device, etc.).

In embodiments, micro-grid manager 104 may simulate changes to the micro-grid to determine whether the micro-grid can remain reliable and sustainable in providing power to the power consuming devices. If the simulation determines the micro-grid can maintain its reliability and sustainability (e.g., power quality levels, power flow, etc.), micro-grid manager 104 may send control information to the power demand devices and/or to the power supply devices. In embodiments, micro-grid manager 104 can send the control information directly to the power consuming devices and/or to the power supply devices, or alternatively, via EM system 120. The control information is used to change the operation of a load and/or a power supply device. If the simulation is not successful, e.g., reliability and sustainability cannot be met, micro-grid manager 104 can manipulate the devices, such as increasing power supply by decreasing power consumption to other devices to enhance the reliability and sustainability model. This information can be sent as control information directly to the power consuming and/or supply devices or via EM system 120.

Although micro-grid manager 104 is shown in FIG. 1 as being incorporated in server 12 along with configuration engine 102, micro-grid manager 104 can be implemented on a separate server or other computing device. For example, configuration engine 102 can be part of a utility operator's centralized distribution system and/or a control infrastructure of a distribution grid. Further, micro-grid manager 104 can be part of a service plane that communicates with devices (e.g., a presence server) in a control infrastructure that services devices in a user/transport plane. Also, it should be understood that UAS system 130 can be an independent part of server 12 and more preferably resides within micro-grid manager 104.

In embodiments, configuration engine 102 and micro-grid manager 104 operate in real-time. In the context of this disclosure, “real-time” is processing information at a rate that is approximately the same or faster than the rate at which the system receives information from one or more devices operating in the system. For example, if a real-time system receives information at a frequency of 1 Hertz, the system outputs information at approximately 1 Hertz or faster under normal operating conditions.

While executing the computer program code, processor 20 can read and/or write data to/from memory 22A, storage system 22B, and/or I/O interface 24. The program code executes the processes of the invention. Bus 26 provides a communications link between each of the components in computing device 14.

Computing device 14 can include any general purpose computing article of manufacture capable of executing computer program code installed thereon (e.g., a personal computer, server, etc.). However, it is understood that computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computing infrastructure is only illustrative of various types of computer infrastructures for implementing the invention. For example, in embodiments, computing system 12 includes two or more computing devices (e.g., a server cluster) that communicate over any type of communications link, such as a network, a shared memory, or the like, to perform the process described herein. Further, while performing the processes described herein, one or more computing devices on computing system 12 can communicate with one or more other computing devices external to computing system 12 using any type of communications link. The communications link can include any combination of wired and/or wireless links; any combination of one or more types of networks (e.g., the Internet, a wide area network, a local area network, a virtual private network, etc.); and/or utilize any combination of transmission techniques and protocols.

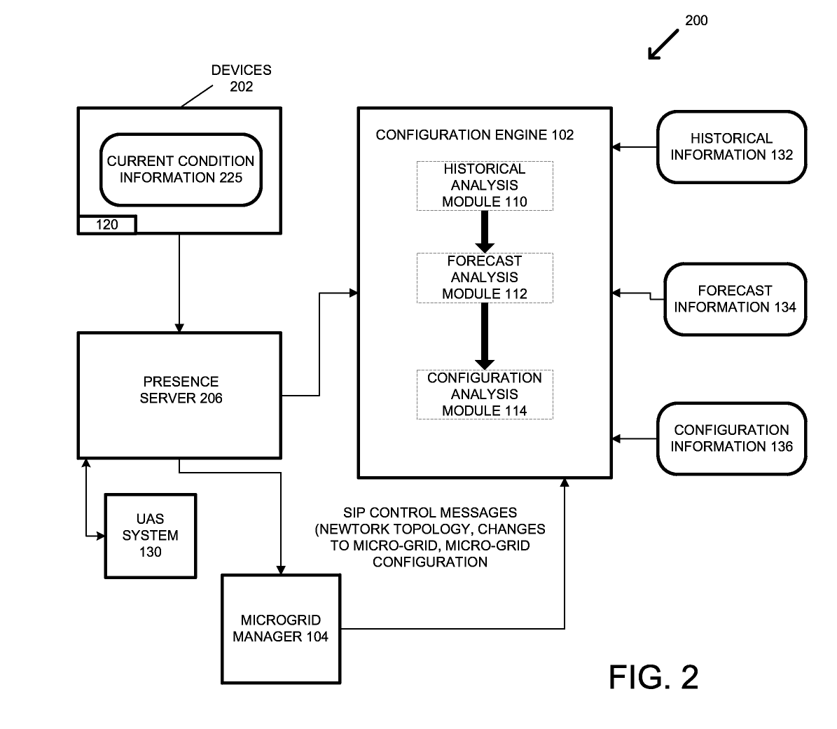

FIG. 2 shows a functional block diagram of an exemplary environment 200 for configuring micro-grids in accordance with aspects of the invention. Environment 200 includes one or more devices 202, one or more presence servers 206, configuration engine 102, micro-grid manager 104, and UAS system 130. Devices 202 may be power supply devices (e.g., a power generator or power storage) and/or power consuming devices (e.g., powered appliances) within a distribution grid. According to further aspects, devices 202 are home-area network-enabled devices (e.g., smart devices) that include network communications interfaces through which the devices may exchange information and/or receive commands using, e.g., SIP or MQTT protocol messaging. For example, devices 202 may be devices 115 shown and described in FIG. 1 (such as power consuming devices and power supply devices) within the distribution grid. Devices 202 may include EM system 120. Micro-grid manager 104 can receive criticality levels of different power consuming devices and electrical characteristics of different power consuming and supply devices from UAS system 130, via presence server 206. In embodiments, micro-grid manager 104 and/or UAS system 130 may be provided as a single or separate computing system. Also, alternatively, while not shown in FIG. 2, it should be understood that device information is received from a trusted third party source, e.g., a device manufacturer, and that such information will not be received from the device itself. In this way, uniform and trusted information can be received by UAS system 130.

In embodiments, EM system 120 can receive device identification, location information, type of device information, and other information from each individual device. This information can then be provided to micro-grid manager 104. Micro-grid manager 104 can send this information to UAS system 130 which makes a determination of the criticality of each individual device. In embodiments, UAS system 130 can receive device information, e.g., device type, locations, etc., from a trusted third party source. Using this third party source information, in combination with the device characteristics, e.g., identifier, location, etc., received from EM system 120, UAS system 130 can then make a determination of criticality. UAS system 130 can also determine the power consumption for power consuming devices and power supply output characteristics of power supply device. This information along with the criticality information can then be provided to micro-grid manager 104. Micro-grid manager 104 can then use this obtained information to determine which power consuming devices are to receive power and which power supply devices are to generate power. The information sent between micro-grid manager 104, EM system 120, and UAS system 130 can be sent and/or processed through presence server 206.

As shown in FIG. 2, devices 202 may communicate via presence servers 206 to provide current condition information 225 (e.g., on/off state, power, voltage, current, faults, service information, etc.) to configuration engine 102 (which may be relayed through micro-grid manager 104). Additionally, devices 202 may receive commands (e.g. SIP control messages) from e.g., micro-grid manager 104 that control devices 202 to modify their operation (e.g., power consumption or/or power generation).

Presence server 206 is software, a system, or combination thereof that accepts, stores and distributes SIP presence information from SIP entities. For example, presence server 206 is a SIP presence server that registers micro-grid manager 104 (e.g., as a watcher application) and devices 202 (e.g., as presentities). As such, the SIP entities illustrated in FIG. 2 can subscribe, publish, and acknowledge information or commands via SIP messages.

According to aspects of the invention, configuration engine 102 determines micro-grids based on historical information 132, forecast information 134, and/or current condition information 225. Current condition information 225 is information received from one or more devices in the electrical grid (e.g., device 202) that describes the current state of the network. Current condition information 225 includes, for example, information such loads, topology information (e.g., identity, host network, location, tie-line), weather, state (on/off, power, voltage, current, impedance, temperature), and network communication status. In embodiments, configuration analysis module 114 determines an optimal micro-grid configuration based on information determined by historical analysis module 110 and forecast analysis module 112. Historical analysis module 110 analyzes historical information 132 to determine a digest of historical information. Forecast analysis module 112 analyzes forecast information 134 and/or the output of the historical analysis module to determine a forecast of near-term conditions in the distribution grid (e.g., devices and their respective power supply and/or demand). Using the forecast of near-term conditions determined by forecast analysis module 112, configuration analysis module 114 determines potential micro-grids.

Still referring to FIG. 2, in accordance with aspects of the invention, micro-grid manager 104 issues SIP control messages based on the configuration information (e.g., configuration information 136) determined by configuration engine 102. The SIP control messages can include information such as network topology changes, changes to the micro-grid configuration, and/or changes to power generations and/or consumption parameters of devices in the micro-grid. For example, after configuration information 136 is determined, the utility operator may review the information and initiate the configuration changes in the distribution grid. Upon initiation, micro-grid manager 104 receives configuration information 136 (e.g., from configuration engine 102 or storage device 22B) and issues commands to the distribution grid to create or modify one or more micro-grids. In embodiments, micro-grid manager 104 transmits SIP control messages (e.g., via presence server 206) that control topology elements (e.g., as switches, fuses and sectionalizers connected to SCADA controllers) to isolate some or all devices 202 into a micro-grid.

Notably, FIG. 2 illustrates an embodiment in which micro-grid manager 104 uses SIP messages to exchange information with devices 202 and presence server 206. However, embodiments of the invention are not limited to this example. As discussed in greater detail below, embodiments may instead use MQTT-messaging or any other suitable communication protocol. Further, as noted above, configuration engine 102 and micro-grid manager 104 may be incorporated in a single system.

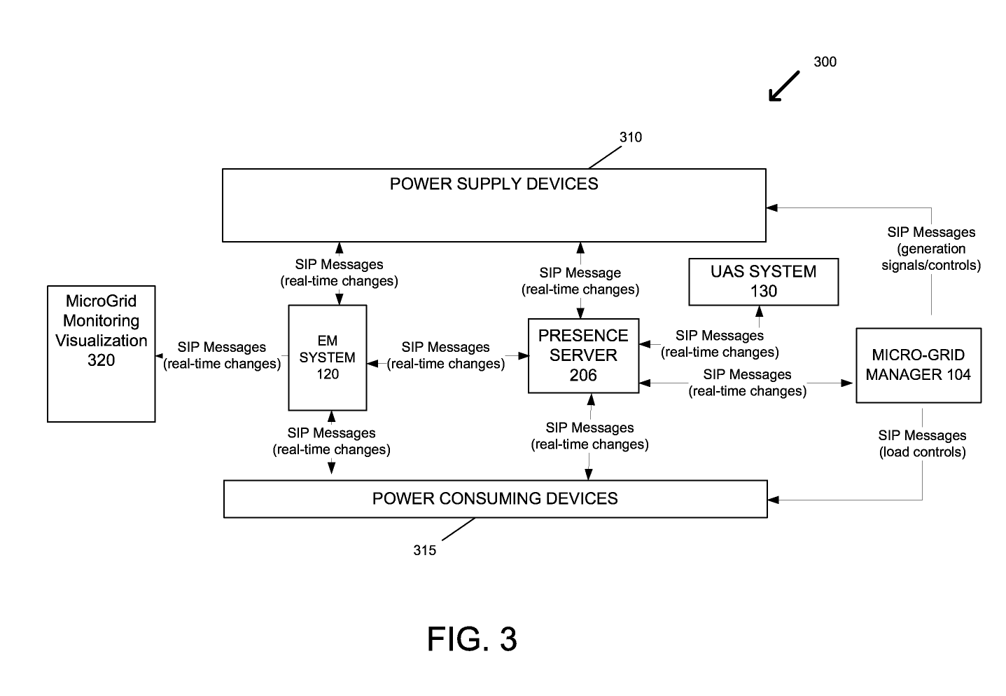

FIG. 3 is a functional block diagram illustrating an exemplary environment 300 for managing a micro-grid using SIP messaging in accordance with aspects of the invention. As shown, micro-grid manager 104 can be communicatively linked with components of exemplary environment 300, including UAS system 130, presence server 206, power supply devices 310 (e.g. devices 115), power consuming devices 315 (e.g., devices 115), micro-grid monitoring and visualization devices 320, and EM system 120. Power supply devices 310 are systems and devices that provide power to the micro-grid, including electric vehicles (e.g., a plug-in electric vehicle or a plug-in hybrid electric vehicle), variable energy resources (e.g., solar cells, wind turbines), and energy storage devices (e.g., batteries, storage capacitors, and fuel cells). Power consuming devices 315 are devices that consume energy (e.g., home appliances, water heaters, swimming pools, programmable controllable thermostats, etc.).

In accordance with aspects of the invention, power supply devices 310 and power consuming devices 315 are network-enabled devices that can form a home-area-network in which the clients (e.g., power supply 310 and power consuming devices 315) use SIP messaging. For example, home area network-enabled power supply devices 310 and power consuming devices 315 devices can register with presence server 206 (e.g., using direct SIP registration with a SIP registrar or using a Zigbee® interface), via EM system 120. Micro-grid manager 104 can receive criticality levels of different power consuming devices and electrical characteristics for power consuming or supply devices from UAS system 130, via presence server 206.

Micro-grid manager 104 communicates with power supply 310, power consuming devices 315, micro-grid monitoring and visualization devices 320, EM system 120, and/or presence server 206, using SIP messaging. The SIP messages may be communicated over an information network, such as a wide area network or the Internet, using, e.g., HTTP or HTTPS. Additionally, the SIP messages can be encrypted using secured SIP and IPSec. Micro-grid manager 104 registers with a SIP registrar (e.g., presence server 206) and subscribes to SIP notifications and messages issued by the various connected home area network devices that belong to the micro-grid. By doing so, micro-grid manager 104 functions as a SIP watcher of power supply devices 310, power consuming devices 315, and/or micro-grid monitoring and visualization devices 320.

Micro-grid manager 104 monitors and controls devices in the micro-grid to ensure that power supply 310 assigned to the micro-grid provide sufficient power to supply power consuming devices 315 that are also within the micro-grid. For example, based on the topology of the micro-grid and current conditions (e.g., current conditions information 225) received in SIP messages issued by the devices in a micro-grid (such as devices 202), micro-grid manager 104 calculates the current conditions of the monitored micro-grid (e.g., the actual or estimated reactive and actual power, voltage, current, etc.). That is, micro-grid manager 104 determines the power flow of the micro-grid based on the current (e.g., real-time) information provided by power supply devices 310 and power energy consuming devices 315.

Based on the current conditions, micro-grid manager 104 can modify the energy production of power supply 310 (e.g., increase the output) and/or reduce the energy consumption of power consuming devices 315 (e.g., decrease the output or shut off appliances, such as air conditioners) to balance the supply and demand of the micro-grid. In the event the supply or demand of the micro-grid cannot be balanced such that the micro-grid is self-sufficient, the micro-grid manager may initiate a change in the micro-grid's configuration by configuration engine 102 (shown in FIG. 1).

Micro-grid monitoring and visualization devices 320 are software, hardware, or combination thereof that gather and present information from one or more of micro-grid manager 104, power supply devices 310, power consuming devices 315 and presence server 206. For example, via micro-grid monitoring and visualization devices 320, an employee of the utility operator (e.g., a distribution dispatcher) may use a centralized advanced monitoring visualization application to view the state of all or set of micro-grids that it managed by one or more micro-grid managers. Further, the utility operator and/or its users can ascertain the current state of micro-grids through advanced visualization watcher applications, which improves the situational awareness of users and utility operator.

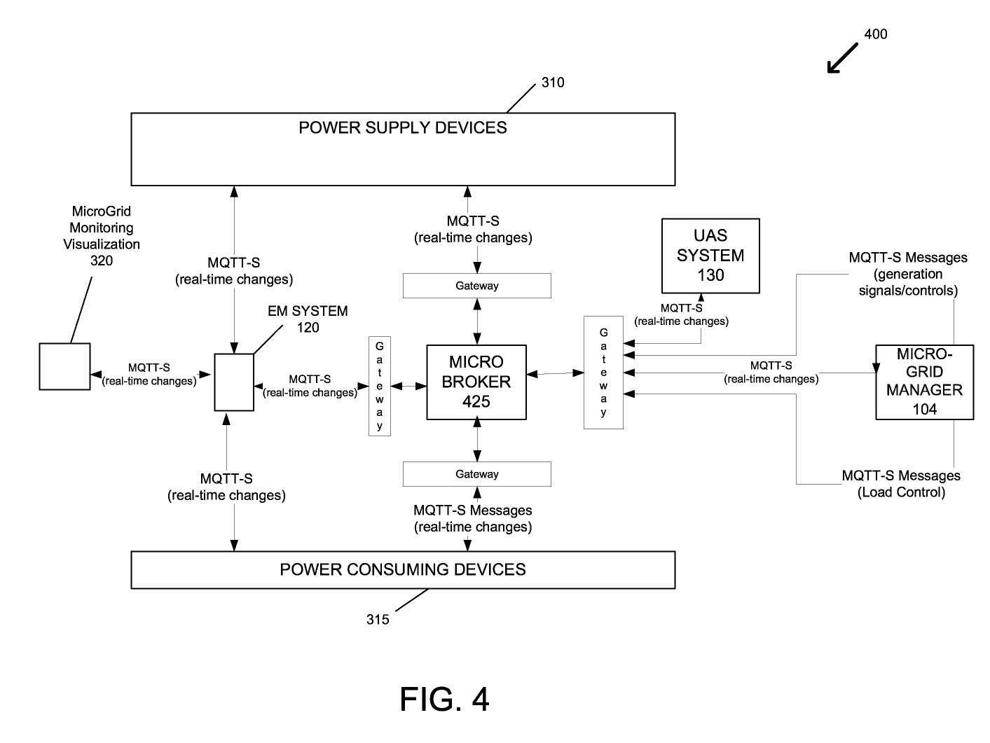

FIG. 4 is a functional block diagram illustrating a system in accordance with aspects of the invention that uses MQTTs and/or MQTT messaging to manage micro-grids in an electrical network. The exemplary embodiment depicted in FIG. 4 includes a micro-grid manager 104 communicatively linked with components of the exemplary environment 400, including power supply devices 310, power consuming devices 315, micro-grid monitoring and visualization devices 320, EM system 120, UAS system 130, gateways 420, and micro-grid broker 425. Power supply 310, energy consuming devices 315, and micro-grid and monitoring and visualization devices 320 are the same or similar to those described above with respect to FIG. 3. In the present implementation, the use of MQTT messaging for wireless communication improves the reliably with respect to a wireless network using SIP.

As shown in FIG. 4, each element in environment 400 may act as a publisher of the information or subscriber of information. Gateways 420 perform protocol transformation by stripping header elements from MQTT messages or adding header elements for MQTTs. Micro-grid broker 425 exchanges messages between clients (i.e., micro-grid manager 104, power supply devices 310, power consuming devices 315, EM system 120, UAS system 130, and micro-grid monitoring and visualization devices 320) to send MQTTs message and for subscribers to receive. Thus, micro-grid broker 425 can store the received and routed messages based on a flag of transported messages that specifies the data retention requirement of the message, even once the message is delivered to desired clients.

Flow Diagrams

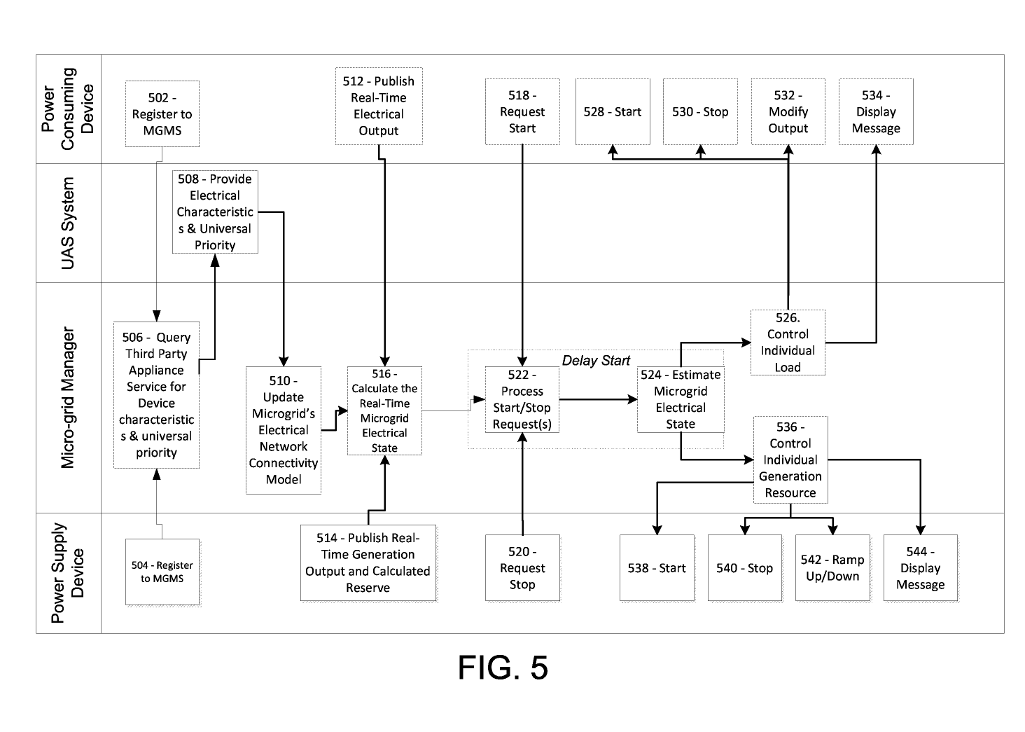

FIGS. 5-8 show exemplary flows for performing aspects of the present invention. For example, the steps of FIGS. 5-8 may be implemented in the environment of FIG. 1 and/or in the block diagrams of FIGS. 2-4. The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. Furthermore, the invention can take the form of a computer program product accessible from the computer-readable storage medium providing program code for use by or in connection with a computer or any instruction execution system or the computer readable signal medium.

FIG. 5 depicts an exemplary swim lane diagram in accordance with aspects of the invention. Specifically, FIG. 5 shows processes for receiving and/or determining power consumption information (e.g., electric load) and power supply information from power consuming devices (e.g., air-conditioning devices, washer/dryers, etc.) and power supply devices (e.g., generators, turbines, etc.), and criticality levels for power consuming devices. This information is used by a micro-grid manager to determine which power consuming devices are to receive power. In embodiments, receiving and transmitting information may be executed by using a SIP communication system or a MQTT communication system as described with aspects of the invention. FIG. 5 includes four exemplary actors: a power consuming device, a UAS system, a micro-grid manager, and a power supply device.

At steps 502 and 504, the micro-grid manager receives registration information from one or more power consuming devices and/or from one or more power supply devices. In embodiments, the registration information is at the appliance level. The registration information for both the power consuming devices and the power supply devices may include an identifier (e.g., a serial number, a name, etc.), location (e.g., a hospital, a house, a movie theatre, etc.), types of devices (e.g., a generator, a micro-turbine, a wind-powered turbine, etc.), and/or any other information. In embodiments, the information may include the age of the devices (e.g., one year old, five years old, etc.) and/or any maintenance information (e.g., overhauling a diesel/natural gas engine on a generator, replacement of a compressor being used in an air handling unit, etc.). The micro-grid manager may store the registration information within a database.

In embodiments, the micro-grid manager may receive the registration information for the devices from an EM system. The EM system itself can be registered with the micro-grid manager. For example, the EM system may send identification information, for the EM system, to the micro-grid manager, such as an identifier (e.g., EM system #1, EM system—Hospital, etc.), a serial number, or any other type of identifier. Accordingly, the micro-grid manager may store this registration information so that the micro-grid can determine that future communications are being sent by a particular EM system. The EM system may also store information that the micro-grid manager is now subscribed to receive information from the EM system.

At step 506, the micro-grid manager queries a UAS system to request criticality levels and electrical characteristics from a UAS system. At step 508, the UAS system determines the electrical characteristics for power consuming devices and power supply devices and the criticality levels as noted above. The UAS system can store electrical characteristics of different power consuming devices, such as the power requirements of the power consuming device (e.g., kilowatt demand, voltage, current, single phase, 3-phase, etc.), time of use (e.g., load is used 24 hours a day, once a week, during a particular time period (such as from 5:00 p.m. to 11 p.m. on weekdays), etc.), high energy consuming power consuming device (based on power requirements, e.g., any load over a threshold, such as 500 kW, etc.), and/or any other type of information. The UAS system can also store information about different devices such as identifier information (e.g., a name, a number, etc.), year of manufacture, type of device (e.g., a generator, a dialysis machine, a soda fountain, etc.), electrical characteristic information, mechanical information, and/or any other type of information that describes the operation characteristics of the device.

The UAS system can also store electrical characteristics of different power supply devices, such as power supply specifications of the power supply device (e.g., stand-by power output, continuous operating power output), whether the power supply device is used for backup, hours of operation (e.g., on-peak hours of operation, off-peak hours of operation, etc.), and/or any other specifications. The electric characteristics can also include maximum power demand, voltage, current, impedance values, and/or any other type of power demand information.

In embodiments, the UAS system determines a criticality level and/or electrical characteristics for the device. For example, the UAS system can analyze the information sent by the micro-grid manager and assign a criticality level, based on the UAS system's method of assigning criticality levels, and electrical characteristics as noted above. In embodiments, the UAS system can change the criticality level based on receiving information relating to an event (e.g., a weather event such as a tornado), change in time, or other changes in the micro-grid.

In embodiments, the UAS system can receive the information from a computing device associated with one or more different sources, such as from the manufacturer of the device, from a utility company associated with the grid, the company operating the micro-grid manager, and/or from any other entity that has information about power consuming and/or supply devices.

In embodiments, the UAS system can determine the criticality level based on inputs from a user into the UAS system which determines the criticality level. Additionally, or alternatively, the UAS system can include an algorithm or any other type of method that determines the criticality level. The UAS system, by way of example, can analyze the type of device, the location of the device, and other information to determine the criticality level. The UAS system may assign values to different factors and then use an analytical system to provide a value that indicates the device's criticality level. This could include assigning a device located in a hospital with a greater criticality value than a device located at a retail store. The UAS system could also provide different devices within a location with different criticality levels. For example, the UAS system may assign a heart monitor a greater criticality level than a washing machine, with both located at a hospital. The UAS system can also change the criticality level based on receiving information about events, such as hurricanes, earthquakes, terrorist attacks, and/or any other type of event that could cause an emergency/catastrophic situation. The UAS system can change non-critical levels for some devices to critical levels, such as when a building (e.g., a school) is assigned as a shelter during an emergency event.

At step 510, the micro-grid manager receives electrical characteristics of a power supply device and the criticality information from the UAS system and uses this information to update the network connectivity. The electrical characteristics may include whether the power supply device is on or off, the maximum power for standby and continuous power generation, voltage, current, impedance values, and/or any other type of electric/mechanical information. The power supply device may have one or more sensors and/or other mechanisms that receive and send the electric characteristics of the power supply device to the micro-grid manager. In embodiments, the power supply device may be registered with the micro-grid manager or may register at the same time that the micro-grid manager receives the electric characteristics of the power supply. The registration information may include identification information (e.g., type of power supply device, location of power supply device, etc.) regarding the power supply device similar to the registration information as described herein.

The micro-grid manager can update the network connectivity based on receiving the electrical characteristics. In embodiments, the network connectivity is a relationship between the available loads and the power supply devices being used within the micro-grid. The micro-grid manager may update a model that includes the electric characteristics of the power consuming device and the power supply device. The electric characteristics may include voltage information, infrastructure of the transmission system, location of each power consuming device and/or power supply within the transmission system, the type of transmission system being used by the micro-grid, and/or any other type of information. By updating the network connectivity, the micro-grid manager can receive real-time information about the power consuming and/or supply devices.

At step 512, the micro-grid manager receives real time load information associated with one or more power consuming devices that are registered with the micro-grid manager. The real time load information can be sent directly between the power consuming device and the micro-grid manager or via an EM system. The real time load information includes the power usage requirements by one or more power consuming devices at the current time or within a time period of the current time. For example, if the current time is 10:00 a.m., then the micro-grid manager receives the load information at 10:00 a.m. or within a time period from the current time (e.g., 10:00:01 a.m., 10:00:05 a.m., etc.). The real time information may be sent automatically by the power consuming device, or the micro-gird manager may request the information from the power consuming devices (e.g., sending messages, pings, etc.).

At step 514, the micro-grid manager receives real time power supply information associated with one or more power supply devices that are registered with the micro-grid manager. The real time power supply information can be sent directly between the power consuming device and the micro-grid manager or via an EM system. The real time power supply information includes the power generation capabilities by one or more power supply devices. The micro-grid manager uses the real time power supply information to update information about one or more power supply devices registered with the micro-grid manager. The real time information may be sent automatically by the power supply device or the micro-grid manager may request the information from the power supply devices (e.g., sending messages, pings, etc.).

At step 516, the micro-grid manager calculates a real time electrical state of the micro-grid using the collected information. Calculating the real time electrical status can include determining the network topology by analyzing which loads are connected with which power supply devices. The micro-grid manager can use the network topology to analyze the types of transmission systems used to connect different power consuming devices with different power supply devices.

The real time electrical status can include calculating power flow by using the network topology, magnitude of power, phase angles of voltage for different buses (e.g., a generation bus) within the micro-grid, real and reactive power flowing through a particular type of transmission system within the micro-grid, and/or other information. In embodiments, the calculated power flow allows for the micro-grid manager to determine the optimal operation of the micro-grid based on the real time information about the power consuming devices and/or power supply devices. The calculated power flow also allows for the micro-grid manager to plan for future expansion of power systems. In embodiments, the power flow calculation may be performed by using logic associated with the Newton-Raphson method, the Gauss-Seidel method, the Fast-decoupled load flow method, other non-linear analysis method, and/or any other linear analysis methods known to those of skill in the art. In embodiments, the micro-grid manager may, additionally or alternatively, use forecast information (e.g., weather) and/or historical information to determine the real time electrical status of the micro-grid.

The micro-grid manager may determine if there are any issues with the power flow. If there are no issues with the power flow, then the micro-grid manager determines if any proactive actions are needed to ensure reliability and sustainability in the micro-grid. If other actions are needed, the micro-grid manager prepares enrollment requests and signal controls to ensure that the micro-grid is reliable and sustainable. The changes made to the real time micro-grid electrical state are stored by the micro-grid manager. If other actions are not needed, then the micro-grid manager stores the micro-grid electrical state without any changes.

If there is an issue with the power flow, then the micro grid manager automatically identifies any remedial actions to solve the power flow issue. These actions may be, e.g., capacitor switching, phase-shift adjustment, load transfer, transformer tap adjustment, etc. The micro-grid manager simulates the remedial actions, and then sends the remedial actions (e.g. capacitor switching, phase-shift adjustment, load transfer, transformer tap adjustment, etc.) to the micro-grid manager to calculate the network topology. The recalculated network topology is then used to determine a power flow that allows for the micro-grid to provide the power for the power consuming devices in the micro-grid.

At steps 518 and 520, a power consuming and/or supply device can request to be started and/or stopped. The start and/or stop requests are published (i.e., sent) to the micro-grid manager.

At step 522, the micro-grid manager receives and/or processes a request to the power consuming device or power supply device. In embodiments, the request may be (i) an enablement request for a power consuming device, (ii) a request to add a power supply device to the micro-grid, (iii) a request to stop sending power from a power supply device, and/or (iv) a request to stop using a particular load. One or more of the requests in (i)-(iv) may be sent directly by the devices to the micro-grid manager or may be sent via an EM system. Based on the request, in embodiments, the micro-grid manager generates control information that allows for the request for power to be granted.

In embodiments, the micro-grid manager may also receive (i) a request to provide power to a power consuming device, (ii) a request to add a power supply device, and/or (iii) a request to stop using a power supply device. Based on the request, the micro-grid manager can provide power for the power consuming device, ramp up particular power supply devices, and/or provide a notice that power is not available for the power consuming device.

At step 524, the micro-grid manager estimates and updates the electrical state of the micro-grid by using any changes, based on the requests to enable a power consuming device, to add a power supply device, and/or to stop providing power from a power supply device. The micro-grid manager may use linear or non-linear calculations to make the estimations for the updated electrical state.

At step 526, the micro-grid manager sends control information for the power consuming device, based on the validation by the micro-grid manager, to the EM system or directly to the power consuming devices. For example, the control information may instruct the power consuming device to operate in a particular manner. The control information may include power input, instructions on outputs from the load (e.g., air-conditioning device can only provide conditioned air at 76 degrees Fahrenheit), and/or any other type of control information. At steps 528, 530, 532, and/or 534, the power consuming device receives the control information and either (i) starts operation, (ii) stops operation, (iii) adjusts the outputs (e.g., increasing the temperature of an air-conditioning unit, reducing the speed of a variable speed drive motor, etc.), and/or (iv) displays a message (e.g., the power consuming device is being powered on, powered off, being denied power, receiving power at a later time, etc.) to the user of the consuming device.

At step 536, the micro-grid manager sends control information for the power supply device. In embodiments, the micro-grid manager may send the control information to the EM system or directly to the power supply devices. The control information may instruct the power supply device to either ramp up power, ramp down power, turn on, and/or turns off. At steps 538, 540, 542, and/or 544, the power supply device receives the control information and can either (i) start up, (ii) turn off, (iii) ramp up power output, (iv) ramp down power output, and/or (v) provide a message regarding the operation of the power supply device to a user.

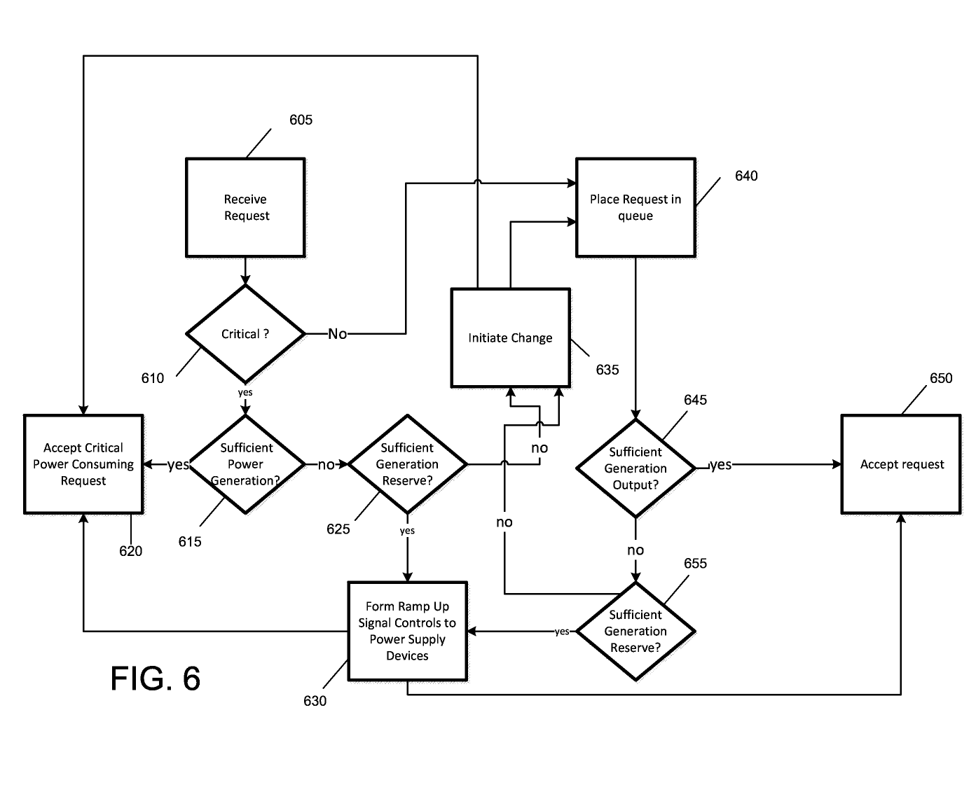

FIG. 6 depicts an exemplary flow of processes for receiving and implementing requests to provide power to a power consuming device within a micro-grid in accordance with aspects of the present invention. The steps of FIG. 6 are described with respect to a micro-grid manager. At step 605, the micro-grid manager receives a request (via SIP or MQTT messaging). In embodiments, the request may be an enablement request from an EM system or directly from the device itself.

As step 610, the micro-grid manager determines whether the request is associated with a critical power consuming device. For example, the micro-grid manager can determine whether the enablement request received from the EM system, or directly from the device itself, is associated with a critical device.

If the request is associated with a critical power consuming device, then the micro-grid manager determines, at step 615, whether there is enough power being generated by power supply device(s) to provide power for the critical power consuming device. If there is enough power at step 620, the micro-grid manager accepts the request. If there is not enough power being generated at step 625, the micro-grid manager determines whether there is enough reserve power to provide the power for the critical power consuming device. If there is enough reserve power, then, at step 630, the micro-grid manager ramps up the power supply from reserve power supply devices to provide power to the critical power consuming devices. The process then returns to the micro-grid manager at step 620. If there is not enough reserve power, at step 635, the micro-grid manager makes changes to other power consuming devices that have a lower priority than the power consuming device requesting the power. For example, the micro-grid manager can divert power from a non-critical device to a critical device. After validating that the request relates to a critical device, if there is no sufficient power reserve (at step 625), the micro-grid manager will both initiate a change, at step 635, and accept the request from the critical device at step 620. Even thought there is a lack of generation output and reserve, initiating the change will divert power from the non-critical power consuming device to the critical power consuming device. This can allow the micro-grid manager to accept the request from the critical power consuming device without impacting the reliability of the network.

At step 640, the micro-grid manager places the request from the critical power consuming device or the requirement for a non-critical power consuming device (that has been stopped) within a queue of requests. The micro-grid manager may place the request first in queue. At step 645, the micro-grid manager determines whether there is power being generated that can provide power for the power consuming device. If so, at step 650, the critical power consuming device or the non-critical power consuming device is provided with power.

If there is not enough generated power at step 655, the micro-grid manager determines if there is enough reserve power. If so, at step 650, the micro-grid manager ramps up the reserve power supply devices so that enough power is generated to meet the demands of the critical/non-critical power consuming device. If there is not enough reserve power, at step 635, the micro-grid manager can place the power request for the critical and/or non-critical power consuming device back into the queue or, alternatively, the micro-grid manager can send a message denying the request. If the micro-grid manager is placing a request for power from a non-critical power consuming device into a queue of power requests, the micro-grid manager may simultaneously accept a critical power consuming device request for power and send instructions so that the critical power consuming device receives the power.

If, at step 610, the request is associated with a non-critical power consuming, at step 640, the micro-grid manager places the request in a queue of requests for power. The request for power is then determined based on sufficient generation output at step 645 and/or sufficient generation reserve at step 655.

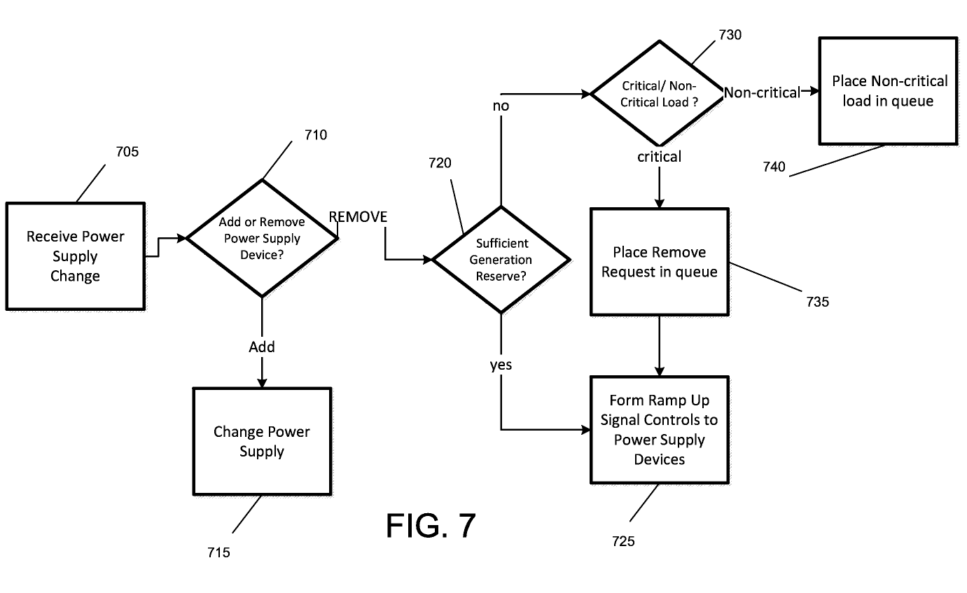

FIG. 7 depicts an exemplary flow of processes for receiving and implementing changes to the power supply within a micro-grid in accordance with aspects of the present invention. At step 705, the micro-grid manager receives and processes a request to change power being supplied by a power supply device. In embodiments, the request may be received from the EM system or directly from the power supply device. At step 710, a determination is made as to whether the request is to stop providing power from a power supply device or to add a power supply device. If the request is to add a power supply device, the micro-grid manager updates the network connectivity model of step 715 to include the additional power. The additional power may occur by adding a power supply device or a no longer operational power consuming device.

If the request is to stop providing power from a power supply device, at step 720, the micro-grid manager determines whether there is sufficient generation reserve. If there is sufficient generation reserve at step 725, the micro-grid manager generates control signals to ramp up power supply from other power supply devices. This also allows the micro-grid manager to continue to provide power to power consuming devices that were receiving power from a previously non-operating power supply device. In embodiments, the ramping up of power may be sent as an instruction to an EM system to ramp up power supply devices managed by the EM system. In embodiments, the micro-grid may directly ramp up power for a power supply device.

If there is not sufficient generation reserve at step 730, the micro-grid manager determines whether a critical or non-critical power consuming device is being powered. If a non-critical power consuming device is being powered at step 740, in embodiments, the micro-grid manager reduces the output of the non-critical power consuming device. In embodiments, the micro-grid manager makes the decision to stop sending power to the non-critical power consuming device and generates control information that is used to control different power consuming devices.

If a critical power consuming device is being powered at step 735, the request to remove the power supply device is placed into a queue so that power is still sent to the critical power consuming device. This may also trigger a signal to ramp up power to other power supply devices that are available, at step 725. When the request to remove the power supply device does occur, other power supply devices can take over providing power to the power consuming device.

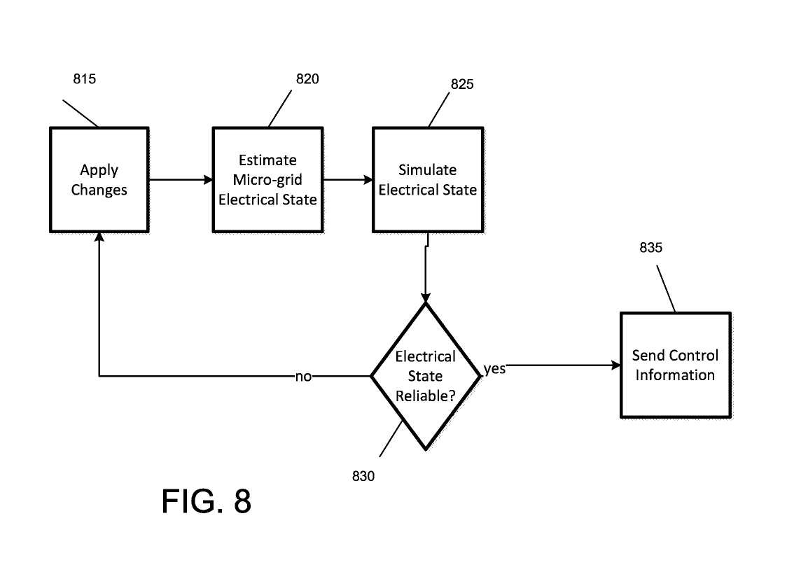

FIG. 8 depicts an exemplary flow of processes of validating changes in operation of devices within a micro-grid in accordance with aspects of the present invention. This may result in the micro-grid maintaining its reliability and sustainability. At step 815, the micro-grid manager applies changes to the real time electrical state based on requests to enable a power consuming device, to add a power supply device, and/or to stop providing power from a power supply device. This may include modifying the operation of a power consuming device (e.g., if the power consuming device is an electric heater, then only provide enough power to provide heat at a particular temperature) and/or a power supply device.

At step 820, the micro-grid manager estimates and updates the electrical state of the micro-grid by using any changes based on the requests to enable a power consuming device, to add a power supply device, and/or to stop providing power from a power supply device. The micro-grid manager may use linear or non-linear calculations to make the estimations for the updated electrical state.

At step 825, the micro-grid manager simulates the activity within the micro-grid based on the updated electrical state of the micro-grid. The simulation determines whether the power flow and quality analysis provides power to the updated micro-grid as well as maintaining the reliability and sustainability of the micro-grid.

If the simulation results determine that the electrical state of the micro-grid can provide the power for the loads at step 830, in embodiments, the micro-grid manager can send control information for the power consuming device and the power supply device to the EM system at step 835. The EM system uses the instructions to control the power consuming device and/or the power supply device. In embodiments, the micro-grid manager can send the control information directly to the device. The control information can instruct the devices on how to operate according to the control information.

If the simulation results determine that the micro-grid cannot provide the power without ensuring the reliability and/or sustainability of the micro-grid, at step 820, the micro-grid manager adds additional constraints to the estimated electric state of the micro-grid to apply changes by returning to step 815. The additional constraints may include capacitor switching, phase-shift adjustment, load transfer, transformer tap adjustment, etc. Once the simulation ensures the reliability and sustainability of the micro-grid, the control information is then sent to the EM system or directly to the devices.

### EXAMPLES

By way of a non-limiting example, a critical-care user has newly installed life-support equipment (e.g., a dialysis machine) that needs to be powered on at all times. The life-support equipment sends its power requirements to an EM system. The EM system sends the information to a micro-grid manager. The micro-grid manager uses this information to query a UAS system which sends critical priority and electrical characteristics of the life support system to the micro-grid manager. The micro-grid manager uses the critical priority and the electrical characteristics to update its network connectivity and verifies whether there is sufficient generation output and reserve available within the micro-grid to accommodate the updated network. With sufficient generation output and reserve available, the micro-grid manager provides power to the life-support equipment. When there is not sufficient generation, the micro-grid manager stops providing power to non-critical power consuming devices and diverts that power to fulfill power requirements for the life-support equipment.

By way of another non-limiting example, a user requests power for non-critical devices (e.g., a television, a DVD player, etc.). The non-critical device sends its power requirements to an EM system. The EM system sends the information to a micro-grid manager. The micro-grid manager uses this information to query a UAS system which sends critical priority and electrical characteristics of the non-critical device to the micro-grid manager. The micro-grid manager uses the electrical characteristics and critical priority to update its network connectivity model and to process the request by analyzing the power supply devices that are monitored and controlled by the micro-grid manager. The micro-grid manager may determine that there is generation output and reserve that is above a threshold that allows for the micro-grid manager to provide power based on the electrical characteristics. Alternatively, the micro-grid manager may determine that the generation output and reserve is insufficient to ensure power for the non-critical devices and also to maintain the reliability of the micro-grid. In the latter scenario, the micro-grid manager denies the request and sends a message to the user of the non-critical devices that power is currently unavailable.

By way of another non-limiting example, a user installs a new power supply device (e.g., distributed generation systems that use a micro-turbine, a generator, etc.) at their location. The new power supply device can provide additional power to the micro-grid. The new power supply device sends its power supply information to a micro-grid manager. The micro-grid manager uses this information to query a UAS system which sends electrical characteristics of the power supply device to the micro-grid manager. The micro-grid manager may use the electrical characteristics to update the electrical network connectivity model with the information regarding the new power supply device. The micro-grid manager can use the electrical characteristics to monitor and control the new power supply device. Further, the micro-grid manager may use the electrical characteristics to generate control information to provide power requirements while still ensuring the overall power quality, reliability and sustainability of the micro-grid.

In embodiments, a service provider, such as a Solution Integrator, could offer to perform the processes described herein. In this case, the service provider can create, maintain, deploy, support, etc., the computer infrastructure that performs the process steps of the invention for one or more customers. These users may be, for example, any business that uses technology. In return, the service provider can receive payment from the customer(s) under a subscription and/or fee agreement and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for configuring micro-grids comprising the steps of:
receiving information of a power consuming device and criticality of the power consuming device from a universal appliance service (UAS) system;
receiving power supply information of one or more power supply devices associated with an electric grid from the UAS system;
receiving a power request from the power consuming device; and
determining, by a computing device, power requirements for the power consuming device based on the information, the criticality of the power consuming device, and the power supply information.

2. The method of claim 1, wherein the determining includes determining that the power consuming device receives the power at a delayed start time.

3. The method of claim 1, wherein the UAS system determines the criticality of the power consuming device based on a particular event.

4. The method of claim 1, wherein the UAS system determines the criticality of the power consuming device based on a device type of the power consuming device.

5. The method of claim 1, wherein the computing device receives the criticality of the power consuming device directly from the UAS system via an application programming interface (API).

6. The method of claim 1, wherein the criticality of the power consuming device is changed from a non-critical power consuming device to a critical power consuming device based on a particular event or period of time.

7. The method of claim 1, wherein the criticality of the power consuming device is provided directly to an energy management (EM) system from the UAS system.

8. The method of claim 7, wherein the criticality of the power consuming device is received via a presence server.

9. The method of claim 1, wherein the information is sent from an energy management (EM) system to the UAS system.

10. The method of claim 9, wherein the information includes identifier information for the power consuming device and location information of the power consuming device.

11. The method of claim 1, wherein the determining the power consuming device receives the power includes:
determining an amount of power being requested by the power consuming device;
determining an amount of generated power and an amount of reserve power;
determining that at least one of the amount of generated power and the amount of reserve power is not sufficient to provide the power being requested to the power consuming device while maintaining integrity of the electric grid; and
delaying the power consuming device's operation.

12. The method of claim 11, wherein the delaying the power consuming device's operation is stopped when the amount of generated power and the amount of reserve power is sufficient to provide the power being requested to the power consuming device.

13. The method of claim 1, further comprising the steps of:
determining an amount of power being requested by the power consuming device;
determining an amount of generated power and an amount of reserve power;
determining that the at least one of the amount of generated power and the amount of reserve power is below a level of power to operate the power consuming device;
shutting down operations of the power consuming device; and
sending a message that the power is not available for the power consuming device.

14. The method of claim 1, wherein:
the steps of claim 1 are provided by a service provider on at least one of a subscription, advertising, and fee basis; and
the service provider at least one of creates, deploys, and maintains a computer infrastructure that executes the steps of claim 1.

15. A system comprising:
a CPU, a computer readable memory and a computer readable storage media;
program instructions to receive information for power consuming devices and power supply information for power supply devices from validated third party sources other than the power consuming devices;
program instructions to determine criticality levels of the power consuming devices based on a location for each of the power consuming devices and a device type for each of the power consuming devices; and
program instructions to send the criticality levels to a micro-grid manager, wherein the micro-grid manager determines that power is available from the power supply devices to operate the power consuming devices based on the criticality levels;
wherein each of the program instructions are stored on the computer readable storage media for execution by the CPU via the computer readable memory.

16. The system of claim 15, further comprising program instructions to receive the information from device manufacturers which are the validated third party sources.

17. The system of claim 16, wherein the information from the device manufacturers includes electrical characteristic information and device identifier information.

18. The system of claim 15, wherein the criticality level of at least one of the power consuming devices changes based on an occurrence of an event.

19. A computer program product for determining criticality, the computer program product comprising a computer usable storage medium having program code embodied in the storage medium, the program code readable/executable by a computing device operable to:
receive real time information for a power consuming device from a UAS system, wherein the real time information includes the criticality of the power consuming device;
receive real time power supply information of a power supply device from the UAS system;
determine a power flow for a micro-grid based on the real time information and the power supply information;
determine reliability of the micro-grid based on the power flow;
determine real time electrical status of the micro-grid based on the real time information and the real time power supply information;
receive an enablement request for power from the power consuming device;
determine whether there is available power for the power consuming device based on the real time electrical status of the micro-grid;
determine whether the power consuming device has priority for the available power over other power consuming devices based on the criticality of the power consuming device; and
send the available power to the power consuming device based on the priority of the power consuming device.

20. The computer program product of claim 19, wherein:
the criticality of the power consuming device is based on the power consuming device's location and device type; and
the determining of the power flow includes using network topology, magnitude of power, and phase angles of voltage associated with a micro-grid.
